(19) United States
(12) Patent Application Publication
(10) Pub. No.: US 2016/0048802 A1
(43) Pub. Date: Feb. 18, 2016

(54) TRANSPORTATION PLANNING FOR A REGIONAL LOGISTICS NETWORK

(71) Applicants: Tianyu LUWANG, Shanghai (CN); Wen-Syan LI, Shanghai (CN); Gufei SUN, Shanghai (CN); Heng WANG, Shanghai (CN)

(72) Inventors: Tianyu LUWANG, Shanghai (CN); Wen-Syan LI, Shanghai (CN); Gufei SUN, Shanghai (CN); Heng WANG, Shanghai (CN)

(21) Appl. No.: 14/459,261

(22) Filed: Aug. 13, 2014

(51) Int. Cl. G06Q 10/08

(52) U.S. Cl. CPC G06Q 10/08355

(57) ABSTRACT

According to an aspect, a system includes transportation module configured to generate a transportation plan for packages scheduled to be routed through a regional logistics network such that the transportation plan minimizes transportation costs. The transportation module may include a pickup plan module, a depot-to-depot plan module, and a delivery plan module. The pickup plan module may be configured to compute a pickup transportation plan for packages to be picked-up from the customers in the customer area of an origin depot. The depot-to-depot plan module may be configured to compute a depot-to-depot transportation plan for packages transferred between the origin depot and a destination depot. The delivery plan module may be configured to compute a delivery transportation plan for delivering packages from the destination depot to the customers within the customer area of the destination depot.

### BACKGROUND

Generally, the business target of a regional logistics network is to successfully delivery packages with minimal costs. Within a regional logistics network, most of the packages may be required to be delivered in a single day. Conventional transportation planning methods may include assigning pickup tasks to vehicles and determining travel paths for assigned vehicles. In most cases, the vehicle that picked up a package for a particular order is not the same vehicle that delivers the package to its destination. Rather, the package may be routed through one or more immediate transportation locations using multiple vehicles for different portions of the travel route. However, conventional transportation planning methods for regional logistics networks that considers multiple constraints (e.g., capacity of different types of vehicles, delivery time, and/or number of available vehicles at each transportation location) in a manner that reduces the overall cost of package delivery is relatively difficult in terms of computing complexity and reasonable processing time. In other words, since regional logistics networks typically compute transportation plans relatively often (e.g., on a daily basis), conventional transportation planning methods for determining optimal transportation plans in terms of reducing cost that involve multiple constraints may have relatively long computation times such the computed plans are no longer relevant.

### SUMMARY

According to an aspect, a system for computing a transportation plan for a regional logistics network may include at least one processor, and a non-transitory computer-readable storage medium including instructions executable by the at least one processor, the instructions configured to implement a transportation module. The transportation module may be configured to generate a transportation plan for packages scheduled to be routed through a regional logistics network such that the transportation plan minimizes transportation costs. The regional logistics network includes depots and hubs. The depots include an origin depot and a destination depot. Each depot may be assigned a customer area serving one or more customers within the customer area.

The transportation module may include a pickup plan module, a depot-to-depot plan module, and a delivery plan module. The pickup plan module may be configured to compute a pickup transportation plan for packages to be picked-up from the customers in the customer area of the origin depot. The depot-to-depot plan module may be configured to compute a depot-to-depot transportation plan for packages transferred between the origin depot and the destination depot including determining whether the packages are to be transported via depot-to-depot routes or hub-to-hub routes. The depot-to-depot routes may indicate to transfer the packages from the origin depot to the destination depot without using the hubs. The hub-to-hub routes may indicate to transfer the packages from the origin depot to the destination depot using the hubs. The delivery plan module may be configured to compute a delivery transportation plan for delivering packages from the destination depot to the customers within the customer area of the destination depot. The transportation plan may include the pickup transportation plan, the depot-to-depot transportation plan, and the delivery transportation plan.

The depot-to-depot plan module may be configured to determine a number of each type of vehicle for the depot-to-depot routes and the hub-to-hub routes. The depot-to-depot plan module may include an integer programming modeler configured to formulate the computation of the depot-to-depot transportation plan as an objective function that minimizes the transportation costs, and a solver configured to solve the objective function in view of a first decision variable and a second decision variable. The first decision variable may include the determination of whether the packages are to be transported via the depot-to-depot routes or the hub-to-hub routes. The second decision variable may include the determination of the number of each type of vehicle for the depot-to-depot routes and the hub-to-hub routes.

The pickup plan module may include a vehicle routing problem (VRP) modeler configured to formulate the computation of the pickup transportation plan as a vehicle routing problem represented by an objective function that minimizes the transportation costs, and a solver configured to solve the objective function to compute the pickup transportation plan for the origin depot. The pickup plan module may be configured to formulate and solve the objective function using integer programming if at least one of the number of vehicles associated with the origin depot and the number of customers with the customer area of the origin depot is equal to or below a threshold value. In other examples, the pickup plan module is configured to formulate and solve the objective function using column generation if at least one of the number of vehicles associated with the origin depot and the number of customers with the customer area of the origin depot is equal to or above a threshold value. The pickup plan module may be configured to evaluate costs of each travel route traveled by vehicles of different types associated with the origin depot, and determine travel routes for the vehicles of different types based on the evaluated costs such that the packages are pickup within the customer area of the origin depot according to the determined travel routes.

The transportation module may be configured to receive order information for a plurality of orders indicating the packages to be routed through the regional logistics network, geographical information providing location information for the customers, the hubs, and the depots, fleet information providing information on vehicles available at the depots and hubs, and/or travel cost information related to the transportation of packages through the regional logistics network for different types of vehicles. The transportation module may be configured to generate the transportation plan based on the order information, the geographical information, the fleet information, and/or the travel cost information. The pickup plan module, the depot-to-depot plan module, and the delivery plan module may be configured to formulate and solve each respective transportation plan independently from each other.

According to another aspect, a non-transitory computer-readable medium storing executable instructions that when executed cause at least one processor to compute a transportation plan for a regional logistics network. The instructions include instructions to generate the transportation plan for packages scheduled to be routed through a regional logistics network such that the transportation plan minimizes transportation costs. The regional logistics network may include depots and hubs. The depots may include an origin depot and a destination depot. Each depot may be assigned a customer area serving one or more customers within the customer area. The instructions to generate the transportation plan includes instructions to compute a pickup transportation plan for packages to be picked-up from the customers within the customer area of the origin depot, compute a depot-to-depot transportation plan for packages transferred between the origin depot and the destination depot including determining whether the packages are to be transported via depot-to-depot routes or hub-to-hub routes. The depot-to-depot routes may indicate to transfer the packages from the origin depot to the destination depot without using the hubs. The hub-to-hub routes may indicate to transfer the packages from the origin depot to the destination depot using the hubs. The instructions may include instructions to compute a delivery transportation plan for delivering packages from the destination depot to the customers within the customer area of the destination depot. The transportation plan may include the pickup transportation plan, the depot-to-depot transportation plan, and the delivery transportation plan.

The instructions to compute the depot-to-depot transportation plan include determine a number of each type of vehicle for the depot-to-depot routes and the hub-to-hub routes. The instructions to compute the depot-to-depot transportation plan include formulate the computation of the depot-to-depot transportation plan as an objective function that minimizes the transportation costs and solve the objective function in view of a first decision variable and a second decision variable. The first decision variable may include the determination of whether the packages are to be transported via the depot-to-depot routes or the hub-to-hub routes. The second decision variable may include the determination of the number of each type of vehicle for the depot-to-depot routes and the hub-to-hub routes.

The instructions to compute the pickup delivery plan include formulate the computation of the pickup transportation plan as a vehicle routing problem represented by an objective function that minimizes the transportation costs and solve the objective function to compute the pickup transportation plan for the origin depot. The instructions to compute the pickup delivery plan include formulate and solve the objective function using integer programming if at least one of the number of vehicles associated with the origin depot and the number of customers with the customer area of the origin depot is equal to or below a threshold value.

The instructions to compute the pickup delivery plan include formulate and solve the objective function using column generation if at least one of the number of vehicles associated with the origin depot and the number of customers with the customer area of the origin depot is equal to or above a threshold value. The instructions to compute the pickup delivery plan include evaluate costs of each travel route traveled by vehicles of different types associated with the origin depot, and determine travel routes for the vehicles of different types based on the evaluated costs such that the packages are pickup from the customers within the customer area of the origin depot according to the determined travel routes. The instructions to compute the pickup transportation plan, the depot-to-depot transportation plan, and the delivery transportation plan include formulate and solve each respective transportation plan independently from each other.

According to another aspect, a method for determining a transportation plan for a regional logistics network includes generating, by at least one processor, a transportation plan for packages scheduled to be routed through a regional logistics network such that the transportation plan minimizes transportation costs. The regional logistics network includes depots and hubs. The depots may include an origin depot and a destination depot. Each depot may be assigned a customer area serving one or more customers within the customer area. The generating may include computing a pickup transportation plan for packages to be picked-up from the customers within the customer area of the origin depot, and computing a depot-to-depot transportation plan for packages transferred between the origin depot and the destination depot including determining whether the packages are to be transported via depot-to-depot routes or hub-to-hub routes. The depot-to-depot routes may indicate to transfer the packages from the origin depot to the destination depot without using the hubs. The hub-to-hub routes may include to transfer the packages from the origin depot to the destination depot using the hubs. The generating may include computing a delivery transportation plan for delivering packages from the destination depot to the customers within the customer area of the destination depot. The transportation plan may include the pickup transportation plan, the depot-to-depot transportation plan, and the delivery transportation plan.

The computing the depot-to-depot transportation plan may include determining a number of each type of vehicle for the depot-to-depot routes and the hub-to-hub routes. The computing the depot-to-depot transportation plan may include formulating the computation of the depot-to-depot transportation plan as an objective function that minimizes the transportation costs, and solving the objective function in view of a first decision variable and a second decision variable. The first decision variable may include the determination of whether the packages are to be transported via the depot-to-depot routes or the hub-to-hub routes. The second decision variable may include the determination of the number of each type of vehicle for the depot-to-depot routes and the hub-to-hub routes.

The details of one or more implementations are set forth in the accompanying drawings and the description below. Other features will be apparent from the description and drawings, and from the claims.

### BRIEF DESCRIPTION OF THE DRAWINGS

FIG. 1 illustrates a system for computing a transportation plan for a regional logistics network according to an aspect.

FIG. 2 illustrates the regional logistics network according to an aspect.

FIG. 3 illustrates a graph of a pickup transportation plan or a delivery transportation plan for an individual depot according to an aspect.

FIG. 4 illustrates a flowchart depicting example operations of formulating and solving the pickup transportation plan or the delivery transportation plan using column generation according to an aspect.

FIG. 5 illustrates a flowchart depicting example operations of the system of FIG. 1 according to an aspect.

### DETAILED DESCRIPTION

The systems and methods discussed herein may include a transportation module configured to determine a transportation plan for a regional logistics network in a manner that reduces overall transportation cost while satisfying multiple constraints and reducing the processing time and/or computing complexity associated for solving transportation routing problems involving different types of travel paths using different types of vehicles.

In some examples, a regional logistics network may include customers, depots (e.g., origin depots and destination depots), and hubs that serve as immediate package transfer locations between the depots. Each of the depots and the hubs may be associated with a fleet of vehicles used to transport packages. Also, the fleets of vehicles may involve different types of vehicles having different package capacities. In some examples, a depot is assigned to serve a single customer area where the customer area includes one or more customers. The transportation module may be configured to interface with other systems related to the transportation of packages such as an order system, a geographic information system (GIS), and a fleet management system.

For end-to-end delivery of packages, the systems and methods discussed herein may divide the transportation problem into distinct sub-problems such as a first sub-problem, a second sub-problem, and a third sub-problem, and formulate and solve these sub-problems independently. The first sub-problem relates to computing a pickup transportation plan for package pickup by the vehicles associated with each origin depot from the customers within its respective customer area in a manner that minimizes transportation costs. The second sub-problem relates to computing a depot-to-depot transportation plan between the origin depots and the destination depots for the transportation of aggregated packages (e.g., packages destined to a particular depot or hub) in a manner that minimizes the transportation costs. The computing of the depot-to-depot transportation plan includes determining whether to use depot-to-depot routes or hub-to-hub routes and determining the number of each type of vehicle required for the depot-to-depot routes and/or the hub-to-hub routes. The third sub-problem relates to computing a delivery transportation plan for package delivery by the vehicles associated with each destination depot to the customers within its customer area in a manner that minimizes the transportation costs. The computation of these sub-problems are provided within an integrated system for the daily operations of a regional logistics network.

In some examples, the transportation module may include a pickup plan module configured to model and solve the first sub-problem (the pickup transportation plan). For each origin depot, the first sub-problem may be characterized as a vehicle routing problem. For example, the pickup plan module may include a vehicle routing problem (VRP) modeler configured to formulate the package assignment and route design for the packages to be picked up within the customer area served by a respective origin depot as a vehicle routing problem, and a solver configured to solve the vehicle routing problem. In some examples, the pickup plan module may be configured to formulate and solve the vehicle routing problem by applying integer programming or column generation in the context of an objective function that minimizes total costs.

The transportation module may include a depot-to-depot plan module configured to model and solve the second sub-problem (the depot-to-depot transportation plan). Included within this analysis, the depot-to-depot plan module may be configured to determine whether the packages are to be transported via the depot-to-depot routes or the hub-to-hub routes and the number of each type of vehicle used for the depot-to-depot routes and the hub-to-hub routes. In some examples, the depot-to-depot plan module may include an integer programming modeler configured to model the second sub-problem as an integer modeling problem, and a solver configured to solve the integer modeling problem in the context of an objective function that minimizes total costs.

In some examples, the transportation module may include a delivery plan module configured to model and solve the third sub-problem (the delivery transportation plan). In some examples, the computation of the delivery transportation plan may be implemented in the same manner as the pickup plan module, e.g., a VRP modeler and solver. For example, the delivery plan module may be configured to formulate and solve the vehicle routing problem by applying integer programming or column generation in the context of an objective function that minimizes total costs.

By employing one or more of the techniques discussed above, the transportation module may be configured to determine a transportation plan (e.g., a combination of one or more of the pickup transportation plan, the depot-to-depot transportation plan, and the delivery transportation plan) that is computational feasible for the daily operations of the regional logistics network. In addition, the results from the transportation module may be used for decision-support of long-term resource procurement and allocation. These and other features are further described with reference to the figures.

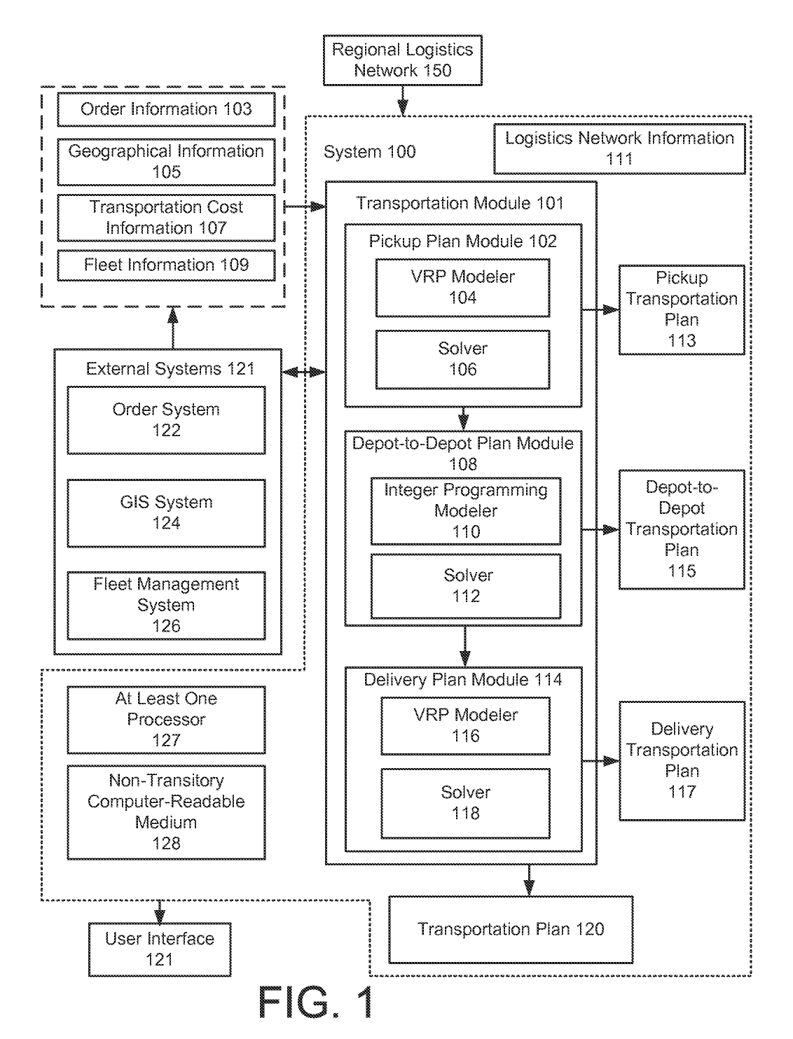

FIG. 1 illustrates a system 100 for computing a transportation plan 120 within a regional logistics network 150 according to an aspect. The system 100 may include a transportation module 101 configured to compute a transportation plan 120 for the regional logistics network 150, at least one processor 127, and a non-transitory computer-readable medium 128 storing executable instructions, that when executed by the at least one processor 127 are configured to implement the transportation module 101 and the functionalities described herein.

The transportation plan 120 may include a cost-effective overall delivery plan for the transportation of packages through the regional logistics network 150 for a certain period of time, e.g., daily delivery plan, multi-day delivery plan, weekly delivery plan, etc. In some examples, for smaller types of logistic networks, the transportation plan 120 may be required to be generated on a daily basis to provide the overall transportation plan for the routing of packages through the network on that day. Therefore, as further described later in the disclosure, the transportation module 101 is implemented in a way that reduces the complexity of solving transportation routing problems such that the transportation plan 120 is generated with relatively short computation times in order to meet the daily operational planning of the regional logistics network 150.

In some examples, for the end-to-end delivery of packages, the transportation plan 120 may include the assignment of packages to types of vehicles, the route designs (also referred to as routes, travel routes, or paths), and the number of each type of vehicle required by the route designs. In some examples, the transportation plan 120 may include a pickup transportation plan 113 for each origin depot, a depot-to-depot transportation plan 115 for transportation between the origin depots and the destination depots, and a delivery transportation plan 117 for each destination depot. In other examples, the transportation plan 120 may include at least one of the pickup transportation plan 113, the depot-to-depot transportation plan 115, and the delivery transportation plan 117, or any combination thereof. Also, in some examples, the transportation plan 120 may include an estimated pickup time, final delivery time, and arrival times at related depots and hubs for the packages routed through the regional logistics network 150. In other examples, the estimated pickup time, final delivery time, and arrival times at the related depots and hubs may be determined (or inferred) from the transportation plan 120.

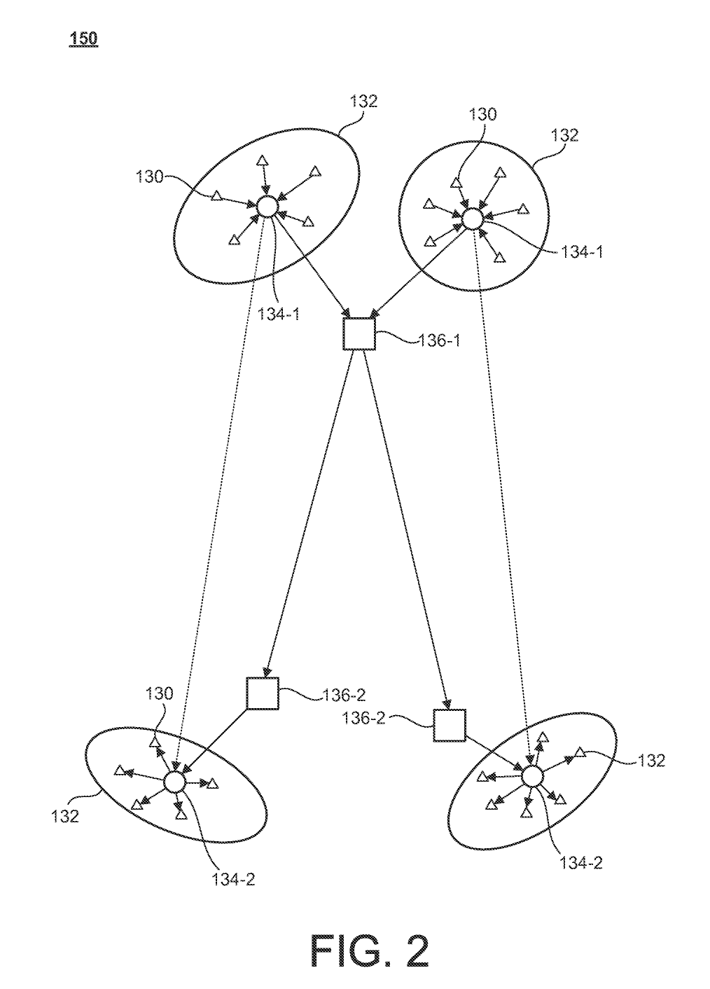

FIG. 2 illustrates the regional logistics network 150 according to an aspect. The regional logistics network 150 may include customer areas 132 having one or more customers 130, depots 134, and hubs 136. It is noted that the regional logistics network 150 depicted in FIG. 2 is used for explanatory purposes only, where the regional logistics network 150 may include any number of customer areas 132, customers 130, depots 134, and hubs 136. In some examples, the regional logistics network 150 may encompass a geographical area for a certain part of the world—as opposed to a worldwide network. Each customer area 132 may be a geographical area encompassing a region of the regional logistics network 150. In some examples, the customer areas 132 do not overlap with each other. In other examples, some of the customer areas 132 overlap with other customer areas 132. Each customer 130 may represent a location (e.g., house, building, business, etc.) where packages are picked up or delivered.

Each depot 134 is assigned to a single customer area 132. For example, each depot 134 is associated with a customer area 132 that does not overlap with a customer area 132 of another depot 134. Each depot 134 may provide pickup and delivery services for the customers 130 within its assigned customer area 132. By assigning a non-overlapping customer area 132 to an individual depot 134, the computation complexity for solving the transportation problem(s) by the transportation plan module 101 may be reduced.

Generally, the depot 134 may be a location, area, or place where vehicles are maintained and dispatched for transporting packages from/to the customers 130 within its assigned customer area 132, and possibly the transporting packages from the depot 134 to another depot 134 or hub 136. Depending on the context, the depots 134 may be characterized as origin depots 134-1 or destination depots 134-2. In general, the depots 134 may be characterized as the origin depots 134-1 when its vehicles perform package pickup tasks from the customers 130 within its customer area 132. In this case, vehicles associated with the origin depot 134-1 may be dispatched from the origin depot 134-1 to pick up the packages from the customers 130 within its assigned customer area 132 according to its designed routes (provided by the pickup transportation plan 113). In general, the depots 134 may be characterized as the destination depots 134-2 when its vehicles perform package delivery tasks. In this case, the vehicles associated with the destination depot 134-2 are dispatched from the destination depot 134-2 to deliver the packages to the customers 130 within its assigned customer area 132 according to the designed routes (provided by the delivery transportation plan 117).

Each depot 134 may be associated with a number of vehicles (e.g., a fleet of vehicles) that serves its customer area 132. The vehicles associated the depots 134 may include one or more types of vehicles. For example, the vehicles may include different sizes such that different types of vehicles have different capacities. For example, a vehicle of a first type may be smaller than a vehicle of a second type, where the first type vehicle has a lower capacity for transporting packages than the second type vehicle.

The hub 136 may be a location, area, or place where vehicles are maintained and dispatched for the transportation of packages from/to another hub 136 or depot 134. In some examples, the hubs 136 may be considered intermediate package transfer locations. In some examples, the hubs 136 may be larger transportation locations than the depots 134. Depending on the context, the hubs 136 may be characterized as origin hubs 136-1 or destination hubs 136-2. In general, the hubs 136 may be characterized as the origin hubs 136-1 when its vehicles travel to other hubs 136 or the destination depots 134-2. Stated another way, the hubs 136 may be characterized as the origin hubs 136-1 when receiving packages from the origin depots 134-1. In general, the hubs 136 may be characterized as the destination hubs 136-2 when receiving packages from the origin hubs 136-1. Stated another way, the hubs 136 may be characterized as the destination hubs 136-2 when its vehicles transport the packages to the destination depots 136-2.

Each hub 136 may be associated with a fleet of vehicles that are available for the transportation of packages. The vehicles associated with the hubs 136 may include multiple types of vehicles having different capacities. In some examples, the hubs 136 may have a larger number of the second type vehicles since the vehicles associated with the hubs 136 generally travel further than the vehicles associated with the depots 134. For instance, generally, smaller vehicles may be deployed at the depots 134 while larger vehicles may be deployed at the hubs 136. Smaller vehicles may provide more flexibility with lower per travel costs (compared under the same distance), and may be better suited for package pickup and delivery. Larger vehicles may provide lower average cost if fully (or substantially) loaded, and may be better suited for relatively longer distance traveling with a relatively large amount of packages. However, the fleets of vehicles associated with the hubs 136 may include smaller and larger vehicles since the larger vehicles may not always be filled to capacity.

For depot-to-depot transportation, packages may be transported in the regional logistics network 150 via two types of transportation modes—a depot-to-depot mode and a hub-to-hub mode. In the depot-to-depot mode, the packages are transported from the origin depots 134-1 to the destination depots 134-2 without using the hubs 136. In some examples, in the depot-to-depot mode, the packages are directly transported from the origin depots 134-1 to the destination depots 134-2. In the hub-to-hub mode, the packages are transported from the origin depots 134-1 to the destination depots 134-2 using the hubs 136. In some examples, in the hub-to-hub mode, the packages are transported from the origin depots 134-1 to the origin hubs 136-1 (that are relatively close to the origin depots 134-1), then transported from the origin hubs 136-1 to the destination hubs 136-2, and then transported from the destination hubs 136-2 to the destination depots 134-2.

Referring back to FIG. 1, in order to determine the transportation plan 120, the transportation module 101 may receive order information 103, geographical information 105, transportation cost information 107, and fleet information 109 from one or more external systems 121. The external systems 121 may be external to the transportation module 101. The external systems 121 may include an order system 122, a geographical information system (GIS) 124, and a fleet management system 126.

Generally, the transportation module 101 may communicate with the external systems 121 to obtain the order information 103, the geographical information 105, the transportation cost information 107, and the fleet information 109. If one or more of the external systems 121 are disposed on application servers remote from the system 100, the transportation module 101 may receive this information via any type of network (e.g., internet, intranet, and/or other types of public/private networks). In other examples, the system 100 may store the order information 103, the geographical information 105, the transportation cost information 107, and the fleet information 109 in one or more databases associated with the system 100, and derive this information when computing the transportation plan 120.

The order system 122 may receive and manage transportation orders submitted by the customers 130 for the transportation of packages through the regional logistics network 150. In some examples, the transportation module 101 may receive the order information 103 from the order system 122. The order information 103 may identify the transportation orders and provide information on the number of packages to be transported (optionally the size/weight of the packages), the pickup and delivery locations (e.g., the customers 130), and/or other type of information associated with the customer orders. The GIS system 124 may store and provide the geographical information 105. The geographical information 105 may include locations of the customers 130, the depots 134, the hubs 136, and the travel distance and/or the travel paths between these transportation locations. The fleet management system 126 may store and provide the fleet information 109. The fleet information 109 may include the types of vehicles associated with each depot 134 and hub 136, and the number of each type of vehicle associated with each depot 134 and hub 136. Also, the fleet information 109 may provide the status of the vehicles (e.g., if it is available for transport), as well as maintenance information associated with the vehicles.

The GIS system 124 and/or the fleet management system 126 may store and provide the transportation cost information 107. The transportation cost information 107 may include the travel costs for each type of vehicle between the transportation locations and unit costs for weights of packages between transportation locations. For example, the transportation cost information 107 may include the costs for travel of a vehicle of a particular type from one hub 136 to another hub 136, the costs for travel of a vehicle of a particular type from one depot 134 to another depot 134, the costs for travel of a vehicle of a particular type from a depot 134 to a hub 136, the costs for travel of a vehicle of a particular type from a customer 130 to a depot 134, and the cost for travel of a vehicle of a particular type from one customer 130 to another customer 130. Also, the transportation cost information 107 may include the average cost for transport unit weight of packages from a depot 134 to another depot 134, the average costs for transport unit weight of packages from a depot 134 to a hub 136, and the average costs for transport unit weight of packages from one hub 136 to another hub 136.

Also, the system 100 may store and manage logistics network information 111. The logistics network information 111 may include information about the regional logistics network 150. In some examples, the logistics network information 111 may identify the set of hubs 136, the set of depots 134, and the set of customers 130, as well as any information related to these transportation locations.

For the end-to-end delivery of packages, the transportation module 101 may divide the transportation problem into distinct sub-problems such as a first sub-problem, a second sub-problem, and a third sub-problem. The first sub-problem relates to computing the pickup transportation plan 113 for package pickup by the vehicles associated with each origin depot 134-1 from the customers 130 within its assigned customer area 132. The second sub-problem relates to computing the depot-to-depot transportation plan 115 between the origin depots 134-1 and the destination depots 134-2 for the transportation of aggregated packages (e.g., packages destined to a destination depot) which may include determining whether to use the depot-to-depot routes (e.g., depot-to-depot mode) or the hub-to-hub routes (e.g., hub-to-hub mode) and/or determining the number of each type of vehicle required for the depot-to-depot routes and/or hub-to-hub routes. The third sub-problem relates to computing the delivery transportation plan 117 for package delivery by the vehicles associated with destination depots 134-2 to the customers 130 within its assigned customer area 132.

In order to compute the pickup transportation plan 113, the depot-to-depot transportation plan 115, and the delivery transportation plan 117, the transportation module 101 may obtain the following inputs (or a subset of the following inputs) which may be obtained or otherwise derived from the order information 103, the geographical information 105, the transportation cost information 107, the fleet information 109, and the logistics network information 111 (or a subset of the information 103, 105, 107, 109, and 111).

Inputs

I Set of hubs, indexed by i
J Set of depots, indexed by j
Kⱼ Set of customers assigned to depot j, indexed by k

Usually we have: Kⱼ∩K_{j′≠j}=Ø

U Set of truck types, indexed by u
CAPᵤ The capacity of truck type u
Nᵢᵤ Number of trucks of type u at hub i
Nⱼᵤ Number of trucks of type u at depot j
DE_{kk′} The amount of packages needed to send from customer k to customer k′
TRAN_{jj′} The amount of aggregated packages from depot j to depot j′

Could be computed as: T RAN_{jj′}=Σ_{kεKj}Σ_{k′εKj′}DE_{kk′}

COST_{ii′u} The cost for one travel of a truck of type u from hub i to hub i′
COST_{jj′u} The cost for one travel of a truck of type u from depot j to depot j′
COSTⱼₖᵤ The cost for one travel of a truck of type u from depot j to customer k
COSTₖⱼᵤ The cost for one travel of a truck of type u from customer k to depot j
COST_{kk′u} The cost for one travel of a truck of type u from customer k to customer k′
UTCOⱼᵢ The average cost for transport unit weight of packages from depot j to hub i
UTCOᵢⱼ The average cost for transport unit weight of packages from hub i to depot j
UTCO_{jj′} The average cost for transport unit weight of packages from depot j to depot j′

The transportation module 101 may include a pickup plan module 102 configured to formulate and solve the first sub-problem, a depot-to-depot plan module 108 configured to formulate and solve the second sub-problem, and a delivery plan module 114 configured to formulate and solve the third sub-problem using the inputs (or a subset thereof) in a manner that minimizes the transportation costs. Also, because the transportation module 101 divides the overall transportation problem into three distinct sub-problems, the complexity associated with computing the transportation plan 120 may be reduced.

The pickup plan module 102 may be configured to compute the pickup transportation plan 113 for the packages to be picked-up from the customers 130 for each origin depot 134-1 within its assigned customer area 132 in a manner that minimizes the travel cost information. In some examples, the pickup plan module 102 computes the pickup transportation plan 113 for each origin depot 134-1, e.g., solves the first sub-problem independently for each origin depot 134-1. The pickup transportation plan 113 may provide the assignment of packages to be picked up from the customers 130 to each type of vehicle, the number of each type of vehicle required to pick up the packages, and the travel routes of the vehicles to carry out the package pickup tasks in a cost effective manner by evaluating the costs of each travel route.

In some examples, for each origin depot 134-1, the first sub-problem may be characterized as a vehicle routing problem. For example, the pickup plan module 102 may include a vehicle routing problem (VRP) modeler 104 configured to formulate the package assignment and route design for the packages to be picked up within its customer area 132 served by a respective origin depot 134-1 as a vehicle routing problem, and a solver 106 configured to solve the vehicle routing problem formulated by the VRP modeler to compute the pickup transportation plan 113 in a manner that minimizes the transportation costs. In some examples, the solver 106 may include any type of optimization solver that solves an objective function that minimizes costs.

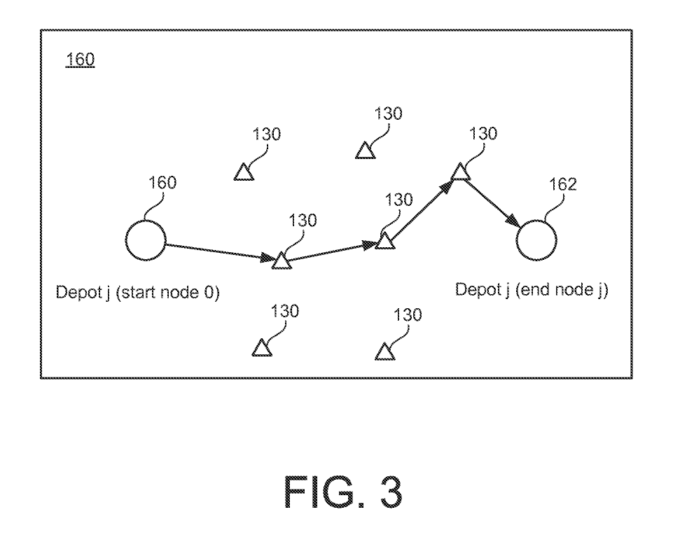

FIG. 3 illustrates a graph 160 of the pickup transportation plan 113 for an individual origin depot 134-1 according to an aspect. Also, the graph 160 may depict the delivery transportation plan 117 for an individual destination depot 134-2 since the same implementations may be used for the delivery transportation plan 117. In some examples, FIG. 3 illustrates an example on how the VRP modeler 104 formulates the first sub-problem to compute the pickup transportation plan 113 for the origin depot 134-1. Referring to FIG. 3, the depot j (e.g., the individual origin depot 134) is represented by a first node 160 and a second node 162. The first node 160 represents the start node (node 0) of the travel path and the second node 162 represents the end node (node j). In this case, the vehicles associated with the depot j start the pickup route from the first node 160 and arrive at the second node. The costs for this model may be provided by Eq. (1) below:

COST₀ₖᵤ=COSTⱼₖᵤ for all kεKⱼ and COST₀ⱼᵤ=0. Eq. (1):

The pickup plan module 102 may be configured to generate a travel path for each vehicle at depot j to cover the customers 130 within its customer area 132 with the lowest total cost. Referring to FIG. 3, if the travel path goes directly from the first node 160 to the second node 162, the pickup plan module 102 is configured to not assign a pickup task to that vehicle. The set of vehicles associated with the depot j may be represented as Mⱼ. For each vehicle m, the pickup plan module 102 may be configured to determine its type through the function TYPE(m).

Referring back to FIG. 1, in some examples, the pickup plan module 102 may be configured to formulate and solve the vehicle routing problem (e.g., the first sub-problem) by applying integer programming or column generation. In some examples, the pickup plan module 102 may be configured to formulate and solve the vehicle routing problem using integer programming if the number of vehicles associated with the origin depot 134-1 and/or the number of customers 130 within its assigned customer area 132 is less than or equal to a threshold value. Also, the pickup plan module 102 may be configured to formulate and solve the vehicle routing problem using column generation if the number of vehicles associated with the origin depot 134-1 and/or the number of customers 130 is greater than or equal to the threshold value. In some examples, the pickup plan module 102 may be configured to switch between the formulation of an objective function (discussed below) that minimizes costs according to the integer programming and the formulation of the objective function that minimizes costs according to the column generation, depending on the amount of the customers 130 and/or the vehicles associated with the origin depot 134-1 for which the pickup transportation plan 113 is computed.

### Integer Programming

In some examples, the VRP modeler 104 of the pickup plan module 102 may be configured to formulate the vehicle routing problem for package pickup using the integer programming. For example, the VRP modeler may formulate the vehicle routing problem using integer programming with the following objective function which minimizes the total cost.

minΣ_{pεP}Σ_{qεQ}Σ_{mεMj}Cost_{pqTYPE(m)}X_{pqm} Eq.(2):

In some examples, the VRP modeler 104 in conjunction with the solver 106 may be configured to determine a binary decision variable X_{pqm} where pεP=Kj∪0,qεQ=Kj∪j, and mεMj. The binary decision variable X_{pqm} may have one of two states—a first state and a second state. In some examples, the first state may be 1 and the second state may be 0. However, any type of two different integers may be used to represent the first state and the second state. If the binary decision variable is X_{pqm}=1, the VRP modeler 104 in conjunction with the solver 106 may determine that the vehicle m travels directly from the node p to node q (e.g., from the first node 160 to the second node 162). As a result, the VRP modeler 104 in conjunction with the solver 106 may determine that this vehicle m is not assigned a pickup task. If the binary decision variable is X_{pqm}=0, the VRP modeler 104 in conjunction with the solver 106 may determine that the vehicle m does not directly travel from the node p to the node q, e.g., this vehicle m is assigned a pickup task for one or more customers 130.

Further, VRP modeler 104 may be configured to model the following constraints to the objective function provided in Eq. (2):

$$\begin{matrix}{\sum }_{p ∈ P} {\sum }_{m ∈ {M}_{j}} {X}_{pkm} = 1 , \\ ∀ k ∈ {K}_{j} & Eq . ( 3 ) \\ {\sum }_{k ∈ {K}_{j}} ( {\sum }_{{k}^{′}} {DE}_{{kk}^{′}} ) {\sum }_{p ∈ P} {X}_{pkm} \leq {CAP}_{TYPE ( m )} , \\ ∀ m ∈ {M}_{j} & Eq . ( 4 ) \\ {\sum }_{q ∈ Q} {X}_{0 qm} = 1 , \\ ∀ m ∈ {M}_{j} & Eq . ( 5 ) \\ {\sum }_{p ∈ P} {X}_{pkm} - {\sum }_{q ∈ Q} {X}_{kqm} = 0 , \\ ∀ k ∈ {K}_{j} , ∀ m ∈ {M}_{j} & Eq . ( 6 ) \\ {\sum }_{p ∈ P} {X}_{pjm} = 1 , \\ ∀ m ∈ {M}_{j} & Eq . ( 7 ) \\ {X}_{pqm} ∈ \{ 0 , 1 \} , \\ ∀ p ∈ P , ∀ q ∈ Q , ∀ m ∈ {M}_{j} & Eq . ( 8 )\end{matrix}$$

The constraint provided in Eq. (3) ensures that each customer 130 is visited once. The constraint provided in Eq. (4) ensures that all packages that a vehicle picks up long its travel route should not exceed its capacity. The constraint provided in Eq. (5) ensures that each vehicle leaves the first node 162. The constraint provided in Eq. (6) ensures that each vehicle should leave for another node after it visits a customer 130. The constraint provided in Eq. (7) ensures that each vehicle arrives at the second node 162.

The solver 106 may be configured to solve the above objective function provided in Eq. (2) with the constraints provided in Eqs. (3)-(8). In addition, the VRP modeler 104 may be configured to model travel time constraints to the objective function such that all (or a portion) of the vehicles finish the pickup tasks within a certain period of time. With this feature, the consolidation or grouping of packages and the depot-to-depot transportation may be started earlier. Further, in some examples, the weights of customer's orders are unknown before they are picked up. As a result, the constraint relating to Eq. (4) can be omitted or replaced by a constraint on the total number of customer sites a vehicle could visit in one travel path.

### Column Generation

In some examples, the VRP modeler 104 may be configured to formulate the vehicle routing problem for package pickup according to the column generation with the following objective function which minimizes the total cost:

$$min {\sum }_{u ∈ U} {\sum }_{r ∈ {R}^{u}} {CO}_{r}^{u} {X}_{r}^{u} \qquad Eq . ( 9 )$$

which minimizes the total cost

For example, the set of all feasible travel paths (travel routes) of depot j for vehicle type u may be represented by R^{u}. The cost of each travel path rεRᵤ traveled by vehicle of type u may be represented as COᵣ^{u}. The variable Aᵣₖ^{u}=1 may mean that the path r (traveled by vehicle of type u) does not visit the customer kεKⱼ. The binary decision variable Xᵣ^{u}•Xᵣ^{u}=1 may mean that the travel path r is traveled by one vehicle of type u. The variable Xᵣ^{u}=0 may mean that path r is not used.

Further, VRP modeler 104 may be configured to model the following constraints to the objective function:

$${\sum }_{u ∈ U} {\sum }_{r ∈ {R}^{u}} {A}_{rk}^{u} {X}_{r}^{u} = 1 , \\ ∀ k ∈ {K}_{j} \qquad Eq . ( 10 )$$

Xᵣ^{u}ε{0,1},∀uεU,∀RεR^{u} Eq.(11):

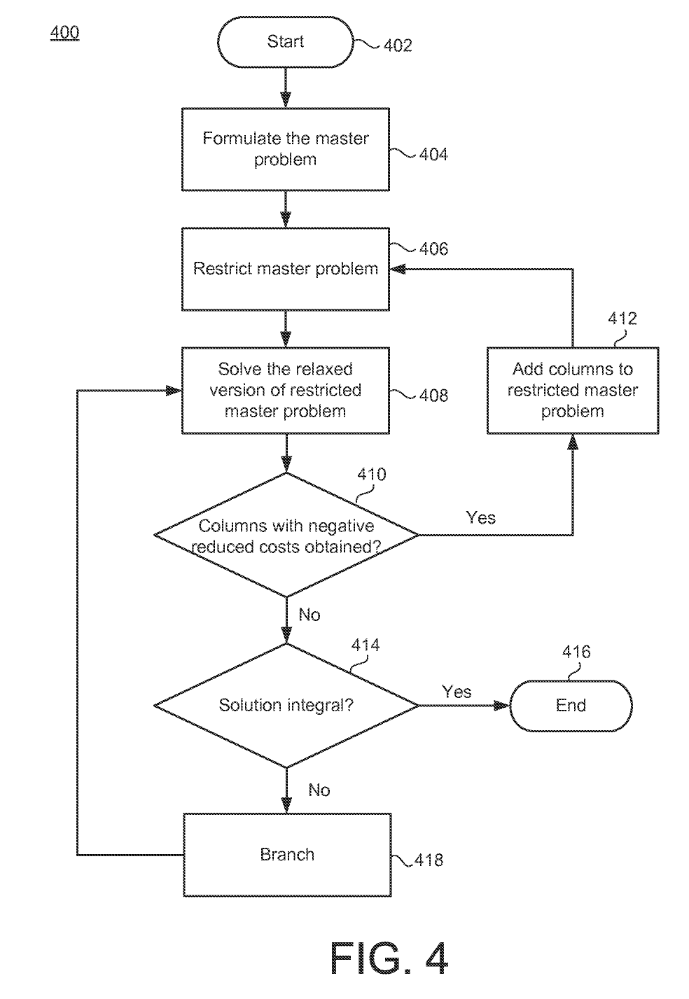

The constraint provided by Eq. (10) ensures that each customer 130 is visited one. In this formulation, each travel path may represent a column of the coefficient matrix of functional constraints. Although the number of all feasible travel paths could be millions (even billions) if the size of the vehicle fleet and/or the number of customers 130 is very large, the VRP modeler 104 in conjunction with the solver 106 is configured to select a limited number of travel paths for a feasible solution. For example, the pickup plan module 102 may start column generation with a relatively small subset of travel paths (e.g., a restricted version of the master problem). Then, the pickup plan module 102 is configured to relax the restricted version of the master problem, and solve the relaxed version of the master problem. For example, the pickup plan module 102 may be configured to relax the binary restriction on Xᵣ^{u} to the [0, 1] interval. Then, based on the resulted dual variables, the pickup plan module 102 is configured to obtain columns (travel paths) having negative reduced costs (or ones having the most negative reduced costs), and these are added to the restricted master problem. The pickup plan module 102 may be configured to repeat this process until no columns with negative reduced costs are obtained. Also, the pickup plan module 102 may be configured to combine the above-processes with a branch and bound algorithm. This process is further explained with reference to FIG. 4.

The sub-problem in this process could be formulated as a shortest path problem. Assuming the dual variables are DLₖ, where kεKⱼ, then the reduced cost for a travel path r (traveled by vehicle type u) would be

$${CO}_{r}^{u} - {\sum }_{k ∈ {K}_{j}} {DL}_{k} {A}_{rk}^{u} .$$

As such, the shortest path problem for vehicle type u may be based on the graph 160 in FIG. 3, while the cost for each arc p→q(COST_{pqu},pεP,qεQ) may be modified to COST_{pqu}−DL_{q} (DLⱼ=0). The pickup plan module 102 may be configured to solve the shortest path problem for each vehicle type. Then, the pickup plan module 102 may be configured to add the minimal one of them to the restricted master problem. Further, the pickup plan module 102 may be configured to add them to the restricted master problem within the same iteration to speed up the computation process.

FIG. 4 illustrates a flowchart 400 depicting example operations of formulating and solving the first sub-problem for the pickup transportation plan 113 according to the column generation according to an aspect. However, because the delivery plan module 114 uses the same techniques as the pickup plan module 102, the below operations could be applied for the formulating and solving the third sub-problem for the delivery transportation plan 117. Although FIG. 4 is illustrated as a sequential, ordered listing of operations, it will be appreciated that some or all of the operations may occur in a different order, or in parallel, or iteratively, or may overlap in time.

After the operation starts (402), the master problem may be formulated (404). For example, the pickup plan module 102 may be configured to formulate the master problem as the objective function provided in Eq. (10) with the constraint provided in Eq. (11). As indicated above, the pickup plan module 102 may be configured to use the objective function to evaluate each travel path for each vehicle having a certain type in terms of costs. Within column generation, each travel path may represent a column of the coefficient matrix of functional constraints. As such, the pickup plan module 102 may be configured to generate the coefficient matrix of functional constraints by modeling a different column within the matrix with a different potential travel path. However, in some examples, the number of potential travel paths may be very large.

The master problem may be restricted (406) and the relaxed version of the restricted master problem may be solved (408). For example, the pickup plan module 102 is configured to select a limited number of travel paths. In particular, the pickup plan module 102 may start column generation with a relatively small subset of paths (e.g., the restricted version of the master problem). Then, the pickup plan module 102 is configured to relax the restricted version of the master problem. For example, the pickup plan module 102 may be configured to relax the binary restriction on Xᵣ^{u} to the [0, 1] interval. Then, the pickup plan module 102 is configured to solve the relaxed version of the master problem, e.g., solve the objective function provided in Eq. (10) with the constraint provided in Eq. (11) in order to determine whether there are any columns (travel paths) with negative reduced costs (410).

If yes, the pickup plan module 102 is configured to add these columns (travel paths) to the restricted master problem (412) and the operations proceed to restricting the master problem (406). For example, after the columns with the negative reduced costs are added as additional columns within the coefficient matrix of functional constraints, the pickup plan module 102 is configured to solve the relaxed version of the master problem with the added columns, e.g., solve the objective function provided in Eq. (10) with the constraint provided in Eq. (11) in order to determine whether there are any columns (travel paths) with negative reduced costs (410). If columns with negative reduced costs are not obtained, it is determined whether the solution is integral (414). If yes, the operations end (416). If no, the operations branch to a point in the middle of the operations relating to solving the relaxed version of the restricted master problem (408).

Referring back to FIG. 1, the depot-to-depot plan module 108 may be configured to model and solve the second sub-problem, e.g., computing the depot-to-depot transportation plan 115 for packages to be delivered between the origin depots 134-1 and the destination depots 134-2 in a manner that minimizes the transportation costs. For example, the depot-to-depot plan module 108 may be configured to determine whether the packages are to be transported via the depot-to-depot routes or the hub-to-hub routes and/or the number of each type of vehicle used for the depot-to-depot routes or the hub-to-hub routes.

Before depot-to-depot transportation, the packages are consolidated and grouped according to their destination depots 134-2. As such, depot-to-depot transportation involves the transportation of aggregated (or grouped) packages. In some examples, the depot-to-depot plan module 108 is configured to determine whether it is more cost effective to use the depot-to-depot routes or the hub-to-hub routes for aggregated packages. The depot-to-depot routes may indicate to transfer the aggregated packages from the origin depots 134-1 to the destination depots 134-2 without using one or more hubs 136. In some examples, the depot-to-depot routes may indicate to directly transfer the aggregated packages from the origin depots 134-1 to the destination depots 134-2. The hub-to-hub routes may indicate to transfer the aggregated packages from the origin depots 134-1 to the destination depots 134-2 using one or more hubs 136. In some examples, the hub-to-hub routes may indicate to transfer the aggregated packages to the origin hubs 136-1 (e.g., located relatively close to the origin depots 134-1), transfer the packages from the origin hubs 136-1 to the destination hubs 136-2 (e.g., located relatively close to the destination depots 134-2), and then transfer the packages from the destination hubs 136-2 to the destination depots 134-2.

In some example, the depot-to-depot plan module 108 may include an integer programming modeler 110 configured to formulate the second sub-problem as an integer modeling problem, and a solver 112 configured to solve the integer modeling problem to compute the depot-to-depot transportation plan 115 for the transportation of aggregated packages between the origin depots 134-1 and the destination depots 134-2 in a manner that minimizes the transportation costs. The solver 112 may be any type of solver that solves an objective function (discussed below) that minimizes costs.

In some examples, referring to Eq. (12) below, the aggregated packages to be transported from depot j to depot j′ may be represented by the parameter TRAN_{jj′}. The depot-to-depot plan module 108 may be configured to solve at least two decision variables including the number of each type of vehicle used for transportation between the hubs 136 and/or the depots 134, and whether the aggregated packages to be sent from the origin depot 134-1 to the destination depot 134-2 should be assigned the hub-to-hub route (e.g., hub i to hub i′) or the depot-to-depot route (e.g., depot ĵ to depot \tilde{j} route). The decision variable Y_{ii′u} may represent the number of vehicles of type u used for the transportation from hub i to hub i′. The decision variable [symbol] may represent the number of vehicles of type u used for the transportation from depot ĵ to depot \tilde{j}. The decision variable B_{jj′ii′} may represent whether the aggregated packages to be sent from depot j to depot j′ should be assigned to the hub i to hub i′ route or the depot ĵ to depot \tilde{j} route.

The depot-to-depot plan module 108 may be configured to model the following objective function that minimizes costs as follows:

$$min {\sum }_{i ∈ I} {\sum }_{{i}^{′} ∈ I , {i}^{′} \neq i} {\sum }_{u ∈ U} {COST}_{{ii}^{′} u} {Y}_{{ii}^{′} u} + {\sum }_{\hat{j} ∈ J} {\sum }_{\tilde{j} ∈ J , \tilde{j} \neq \hat{j}} {\sum }_{u ∈ U} {COST}_{\hat{j} {\tilde{j}}_{u}} {Y}_{\hat{j} {\tilde{j}}_{u}} + {\sum }_{j ∈ J} {\sum }_{{j}^{′} ∈ J , {j}^{′} \neq j} {TRAN}_{{jj}^{′}} [ ( {UTCO}_{ji} + {UTCO}_{{i}^{′} {j}^{′}} ) {B}_{{jj}^{′} {ii}^{′}} + ( {UTCO}_{j \hat{j}} + {UTCO}_{\tilde{j} {j}^{′}} ) {B}_{{jj}^{′} \hat{j} \tilde{j}} ] \qquad Eq . ( 12 )$$

The total cost may include the hub-to-hub transportation cost, the direct depot-to-depot transportation cost, and the extra cost caused by short distance package movement (e.g., depot j to hub i, hub i′ to depot j′, depot j to depot ĵ, and depot \tilde{j} to depot j′.

The objective function may be subject to the following constraints:

$$\begin{matrix}{\sum }_{{i}^{′} ∈ I , {i}^{′} \neq i} {Y}_{{ii}^{′} u} \leq {N}_{iu} , ∀ i ∈ I , ∀ u ∈ U & Eq . ( 13 ) \\ {\sum }_{\tilde{j} ∈ J , \tilde{j} \neq \hat{j}} {Y}_{\hat{j} \tilde{j} u} \leq {N}_{\hat{j} i} , \\ ∀ \hat{j} ∈ J , ∀ u ∈ U & Eq . ( 14 ) \\ {\sum }_{j ∈ J} {\sum }_{{j}^{′} ∈ J , {j}^{′} \neq j} {TRAN}_{{jj}^{′}} {B}_{{jj}^{′} {ii}^{′}} \leq {\sum }_{u ∈ U} {CAP}_{u} {Y}_{{ii}^{′} u} , \\ ∀ i ∈ I , ∀ {i}^{′} ∈ I , {i}^{′} \neq i & Eq . ( 15 ) \\ {\sum }_{j ∈ J} {\sum }_{{j}^{′} ∈ J , {j}^{′} \neq j} {TRAN}_{{jj}^{′}} {B}_{{jj}^{′} \hat{j} \tilde{j}} \leq {\sum }_{u ∈ U} {CAP}_{u} {Y}_{{ }^{\hat{j} \tilde{j} u}} , \\ ∀ \hat{j} ∈ J , ∀ \tilde{j} ∈ J , \tilde{j} \neq \hat{j} & Eq . ( 16 ) \\ {Y}_{{ii}^{′} u} \geq 0 , \\ ∀ i ∈ I , ∀ {i}^{′} ∈ I , {i}^{′} \neq i , ∀ u ∈ U & Eq . ( 17 ) \\ {Y}_{{ii}^{′} u} ∈ Z , \\ ∀ i ∈ I , ∀ {i}^{′} ∈ I , {i}^{′} \neq i , ∀ u ∈ U & Eq . ( 18 ) \\ {Y}_{\hat{j} \tilde{j} u} \geq 0 , \\ ∀ \hat{j} ∈ J , ∀ \tilde{j} ∈ J , \tilde{j} \neq \hat{j} , ∀ u ∈ U & Eq . ( 19 ) \\ {Y}_{\hat{j} \tilde{j} u} ∈ Z , \\ ∀ \hat{j} ∈ J , ∀ \tilde{j} ∈ J , \tilde{j} \neq \hat{j} , ∀ u ∈ U & Eq . ( 20 ) \\ {B}_{{jj}^{′} {ii}^{′}} ∈ \{ 0 , 1 \} , \\ ∀ j ∈ J , ∀ {j}^{′} ∈ J , {j}^{′} \neq j , ∀ i ∈ I , ∀ {i}^{′} ∈ I , {i}^{′} \neq i & Eq . ( 21 ) \\ {B}_{{jj}^{′} \hat{j} \tilde{j}} ∈ \{ 0 , 1 \} , \\ ∀ j ∈ J , ∀ {j}^{′} ∈ J , {j}^{′} \neq j , ∀ \hat{j} ∈ J , ∀ \tilde{j} ∈ J , \tilde{j} \neq \hat{j} & Eq . ( 22 )\end{matrix}$$

The constraint provided in Eq. (13) may ensure that the used vehicles of each type should not exceed the number of available vehicles at each hub 136. The constraint provided in Eq. (14) ensures that the vehicles of each type should not exceed the number of available vehicles at each depot 134. The constraint provided in Eq. (15) ensures that the amount of packages transported through each hub-to-hub route should not exceed the respective total transportation capacity. The constraint provided in Eq. (16) ensures that the amount of packages transported through each direct depot-to-depot route should not exceed the respective total transportation capacity. The total amount of decision variables could be reduced by restricting the average unit cost on short distance movement. In some examples, the variable B_{jj′ii′}=0 if UTCOⱼᵢ or UTCO_{i′j′} is set above certain threshold. In some examples, the variable [symbol] =0 if UTCO_{jĵ}or UTCO_{\tilde{j}j′}, is set above a certain threshold. This integer programming problem may be solved by the solver 112.

In some examples, the transportation module 101 may include a delivery plan module 114 configured to model and solve the third sub-problem, e.g., computing the delivery transportation plan 117 for delivering the packages to the customers 130, individually, for each destination depot 134-2. Similar to the pickup plan module 102, for each destination depot 134-2, the third sub-problem may be characterized as a vehicle routing problem. For example, the delivery plan module 114 may include a VRP modeler 116 configured to formulate the package assignment and route design for the packages to be delivered within the customer area 132 served by a respective destination depot 134-2 as a vehicle routing problem, and a solver 118 configured to solve the vehicle routing problem to compute the delivery transportation plan 117. Similar to the pickup plan module 102, the delivery plan module 114 may be configured to formulate and solve the vehicle routing problem (e.g., the third sub-problem) by applying integer programming or column generation in the same manner discussed above.

Referring to FIG. 1, in some examples, the transportation module 101 may be configured to send the transportation plan 120 (e.g., the pick transportation plan 113, the depot-to-depot transportation plan 115, and/or the delivery transportation plan 117) to one or more of the external systems 121. For example, the transportation module 101 may be configured to provide the transportation plan 120 to the order system 122 and/or the fleet management system 126. In some examples, the transportation module 101 may be configured to provide the transportation plan 120 to a user interface 121 so that the information contained within the transportation plan 120 may be displayed.

The non-transitory computer-readable storage medium 128 may include one or more non-volatile memories, including by way of example semiconductor memory devices, e.g., EPROM, EEPROM, and flash memory devices; magnetic disks, e.g., internal hard disks or removable disks; magneto-optical disks; and CD-ROM and DVD-ROM disks. Besides storing executable instructions, the non-transitory computer-readable storage medium 128 may also store any type of database structure discussed herein. The at least one processor 127 may include any type of special purpose logic circuitry, e.g., an FPGA (field programmable gate array) or an ASIC (application-specific integrated circuit). The at least one processor 127 may include one or more processors coupled to a semi-conductor substrate.

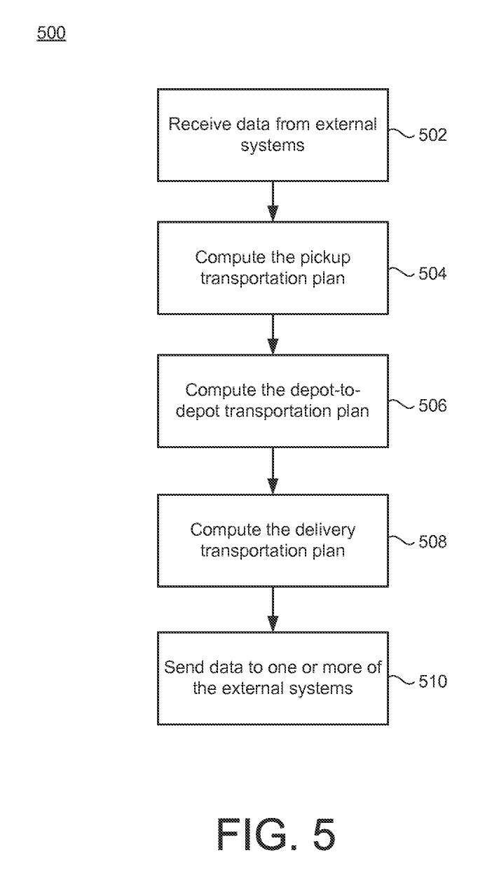

FIG. 5 illustrates a flowchart 500 depicting example operations of the system 100 of FIG. 1 according to an aspect. Although FIG. 5 is illustrated as a sequential, ordered listing of operations, it will be appreciated that some or all of the operations may occur in a different order, or in parallel, or iteratively, or may overlap in time.

Data may be received from the external systems (502). For example, the transportation module 101 is configured to receive the order information 103 for a plurality of orders indicating the packages to be routed through the regional logistics network 150, the geographical information 105 providing location information for the customers 130, the hubs 136, and the depots 134, the fleet information 109 providing information on the vehicles available at the depots 134 and hubs 136, and the travel cost information related to the transportation of packages through the regional logistics network 150. The transportation module 101 may communicate with the external systems 121 to obtain the order information 103, the geographical information 105, the transportation cost information 107, and the fleet information 109. As discussed below, the transportation module 101 is configured to generate the transportation plan 120 based on the order information 103, the geographical information 105, the fleet information 109, and the travel cost information 107.

The pickup transportation plan may be computed (504). For example, the pickup plan module 102 is configured to compute the pickup transportation plan 113 for the origin depot 134-1 for the packages to be picked-up from the customers 130 within the customer area 132 for the origin depot 134-1. In some examples, the pickup plan module 102 may be implemented as VRP modeler 104 configured to formulate the computation of the pickup transportation plan 113 as a vehicle routing problem represented by an objective function that minimizes the transportation costs, and the solver 106 configured to solve the objective function to compute the pickup transportation plan 113 for the origin depot 134-1.

In some examples, the pickup plan module 102 is configured to formulate and solve the objective function using integer programming (e.g., Eqs. (2)-(8)) if at least one of the number of vehicles associated with the origin depot 134-1 and the number of customers 130 with the customer area 132 is equal to or below a threshold value. In other examples, the pickup plan module 102 is configured to formulate and solve the objective function using column generation (e.g., Eqs. (10)-(11)) if at least one of the number of vehicles associated with the origin depot 134-1 and the number of customers 130 with the customer area 132 is equal to or above the threshold value. In some examples, the pickup plan module 102 is configured to formulate and solve the objective function using the column generation approach based on the operations discussed in FIG. 4.

In some examples, according to either the column generation or the integer programming, the pickup plan module 102 is configured to evaluate the costs of each travel route traveled by vehicles of different types associated with the origin depot 134-1, and determine travel routes for the vehicles based on the evaluated costs such that the packages are pickup within the customer area 132 according to the determined travel routes.

The depot-to-depot transportation plan may be computed (506). For example, the depot-to-depot plan module 108 is configured to compute the depot-to-depot transportation plan 115 for packages transferred between the origin depot 134-1 and the destination depot 134-2 including determining whether the packages are to be transported via the depot-to-depot routes or the hub-to-hub routes. The depot-to-depot routes indicate to transfer the packages from the origin depot 134-1 to the destination depot 134-2 without using the hubs 136. The hub-to-hub routes indicate to transfer the packages from the origin depot 134-1 to the destination depot 134-2 using the hubs 136. In some examples, the depot-to-depot plan module 108 is configured to determine the number of each type of vehicle for the depot-to-depot routes and the hub-to-hub routes.

In some examples, the depot-to-depot plan module 108 is implemented by the integer programming modeler 110 configured to formulate the computation of the depot-to-depot transportation plan 113 as an objective function (e.g., Eqs. (12)-(22)) that minimizes the transportation costs, and the solver 112 configured to solve the objective function in view of a first decision variable and a second decision variable. The first decision variable may include the determination of whether the packages are to be transported via the depot-to-depot routes or the hub-to-hub routes. The second decision variable includes the determination of the number of each type of vehicle for the depot-to-depot routes and the hub-to-hub routes.

The delivery transportation plan may be computed (508). For example, the delivery plan module 114 is configured to compute the delivery transportation plan 117 for delivering the packages from the destination depot 134-2 to the customers 130 within the customer area 132 of the destination depot 134-2. In some examples, the delivery plan module 114 is implemented by the VRP modeler 116 configured to formulate the computation of the delivery transportation plan 117 as a vehicle routing problem represented by an objective function that minimizes the transportation costs, and the solver 118 configured to solve the objective function to compute the delivery transportation plan 117 for the destination depot 134-2.

In some examples, the delivery plan module 114 is configured to formulate and solve the objective function using the integer programming approach (e.g., Eqs. (2)-(8)) if at least one of the number of vehicles associated with the destination depot 134-2 and the number of customers 130 with its customer area 132 is equal to or below a threshold value. In other examples, the delivery plan module 114 is configured to formulate and solve the objective function using the column generation approach (e.g., Eqs. (10)-(11)) if at least one of the number of vehicles associated with the destination depot 134-2 and the number of customers 130 with its customer area 132 is equal to or above the threshold value. In some examples, the delivery plan module 114 is configured to formulate and solve the objective function using the column generation approach based on the operations discussed in FIG. 4. In either case, in some examples, the delivery plan module 114 is configured to evaluate the costs of each travel route traveled by vehicles of different types associated with the destination depot 134-2, and determine travel routes for the vehicles based on the evaluated costs such that the packages are delivered to the customers 130 within its customer area 132 according to the determined travel routes in a cost-effective manner.

Data may be sent to one or more of the external systems (510). In some examples, the transportation module 101 may be configured to send the transportation plan 120 to one or more of the external systems 121. For example, the transportation module 101 may be configured to provide the transportation plan 120 to the order system 122 and/or the fleet management system 126. In some examples, the transportation module 101 may be configured to provide the transportation plan 120 to the user interface 121 so that the information contained within the transportation plan 120 may be displayed.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program having the non-transitory computer readable medium, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. The programmable processors may be coupled to one or more semiconductor substrates. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system for computing a transportation plan for a regional logistics network, the system comprising:
at least one processor;
a non-transitory computer-readable storage medium including instructions executable by the at least one processor, the instructions configured to implement,
a transportation module configured to generate a transportation plan for packages scheduled to be routed through a regional logistics network such that the transportation plan minimizes transportation costs, the regional logistics network including depots and hubs, the depots including an origin depot and a destination depot, each depot being assigned a customer area serving one or more customers within the customer area, the transportation module including,
a pickup plan module configured to compute a pickup transportation plan for packages to be picked-up from the customers in the customer area of the origin depot;
a depot-to-depot plan module configured to compute a depot-to-depot transportation plan for packages transferred between the origin depot and the destination depot including determining whether the packages are to be transported via depot-to-depot routes or hub-to-hub routes, the depot-to-depot routes indicating to transfer the packages from the origin depot to the destination depot without using the hubs, the hub-to-hub routes indicating to transfer the packages from the origin depot to the destination depot using the hubs; and
a delivery plan module configured to compute a delivery transportation plan for delivering packages from the destination depot to the customers within the customer area of the destination depot, wherein the transportation plan includes the pickup transportation plan, the depot-to-depot transportation plan, and the delivery transportation plan.

2. The system of claim 1, wherein the depot-to-depot plan module is configured to determine a number of each type of vehicle for the depot-to-depot routes and the hub-to-hub routes.

3. The system of claim 2, wherein the depot-to-depot plan module includes an integer programming modeler configured to formulate the computation of the depot-to-depot transportation plan as an objective function that minimizes the transportation costs, and a solver configured to solve the objective function in view of a first decision variable and a second decision variable, the first decision variable including the determination of whether the packages are to be transported via the depot-to-depot routes or the hub-to-hub routes, the second decision variable including the determination of the number of each type of vehicle for the depot-to-depot routes and the hub-to-hub routes.

4. The system of claim 1, wherein the pickup plan module includes a vehicle routing problem (VRP) modeler configured to formulate the computation of the pickup transportation plan as a vehicle routing problem represented by an objective function that minimizes the transportation costs, and a solver configured to solve the objective function to compute the pickup transportation plan for the origin depot.

5. The system of claim 4, wherein the pickup plan module is configured to formulate and solve the objective function using integer programming if at least one of the number of vehicles associated with the origin depot and the number of customers with the customer area of the origin depot is equal to or below a threshold value.

6. The system of claim 4, wherein the pickup plan module is configured to formulate and solve the objective function using column generation if at least one of the number of vehicles associated with the origin depot and the number of customers with the customer area of the origin depot is equal to or above a threshold value.

7. The system of claim 1, wherein the pickup plan module is configured to evaluate costs of each travel route traveled by vehicles of different types associated with the origin depot, and determine travel routes for the vehicles of different types based on the evaluated costs such that the packages are pickup within the customer area of the origin depot according to the determined travel routes.

8. The system of claim 1, wherein the transportation module is configured to receive order information for a plurality of orders indicating the packages to be routed through the regional logistics network, geographical information providing location information for the customers, the hubs, and the depots, fleet information providing information on vehicles available at the depots and hubs, and travel cost information related to the transportation of packages through the regional logistics network for different types of vehicles, wherein the transportation module is configured to generate the transportation plan based on the order information, the geographical information, the fleet information, and the travel cost information.

9. The system of claim 1, wherein the pickup plan module, the depot-to-depot plan module, and the delivery plan module is configured to formulate and solve each respective transportation plan independently from each other.

10. A non-transitory computer-readable medium storing executable instructions that when executed cause at least one processor to compute a transportation plan for a regional logistics network, the instructions comprising instructions to:
generate a transportation plan for packages scheduled to be routed through a regional logistics network such that the transportation plan minimizes transportation costs, the regional logistics network including depots and hubs, the depots including an origin depot and a destination depot, each depot being assigned a customer area serving one or more customers within the customer area, the instructions to generate the transportation plan including instructions to,
compute a pickup transportation plan for packages to be picked-up from the customers within the customer area of the origin depot;
compute a depot-to-depot transportation plan for packages transferred between the origin depot and the destination depot including determining whether the packages are to be transported via depot-to-depot routes or hub-to-hub routes, the depot-to-depot routes indicating to transfer the packages from the origin depot to the destination depot without using the hubs, the hub-to-hub routes indicating to transfer the packages from the origin depot to the destination depot using the hubs; and
compute a delivery transportation plan for delivering packages from the destination depot to the customers within the customer area of the destination depot, wherein the transportation plan includes the pickup transportation plan, the depot-to-depot transportation plan, and the delivery transportation plan.

11. The non-transitory computer-readable medium of claim 10, wherein the instructions to compute the depot-to-depot transportation plan include determine a number of each type of vehicle for the depot-to-depot routes and the hub-to-hub routes.

12. The non-transitory computer-readable medium of claim 11, wherein the instructions to compute the depot-to-depot transportation plan include:
formulate the computation of the depot-to-depot transportation plan as an objective function that minimizes the transportation costs; and
solve the objective function in view of a first decision variable and a second decision variable, the first decision variable including the determination of whether the packages are to be transported via the depot-to-depot routes or the hub-to-hub routes, the second decision variable including the determination of the number of each type of vehicle for the depot-to-depot routes and the hub-to-hub routes.

13. The non-transitory computer-readable medium of claim 10, wherein the instructions to compute the pickup delivery plan include:
formulate the computation of the pickup transportation plan as a vehicle routing problem represented by an objective function that minimizes the transportation costs; and
solve the objective function to compute the pickup transportation plan for the origin depot.

14. The non-transitory computer-readable medium of claim 13, wherein the instructions to compute the pickup delivery plan include:
formulate and solve the objective function using integer programming if at least one of the number of vehicles associated with the origin depot and the number of customers with the customer area of the origin depot is equal to or below a threshold value.

15. The non-transitory computer-readable medium of claim 13, wherein the instructions to compute the pickup delivery plan include:
formulate and solve the objective function using column generation if at least one of the number of vehicles associated with the origin depot and the number of customers with the customer area of the origin depot is equal to or above a threshold value.

16. The non-transitory computer-readable medium of claim 10, wherein the instructions to compute the pickup delivery plan include:
evaluate costs of each travel route traveled by vehicles of different types associated with the origin depot; and
determine travel routes for the vehicles of different types based on the evaluated costs such that the packages are pickup from the customers within the customer area of the origin depot according to the determined travel routes.

17. The non-transitory computer-readable medium of claim 10, wherein the instructions to compute the pickup transportation plan, the depot-to-depot transportation plan, and the delivery transportation plan include formulate and solve each respective transportation plan independently from each other.

18. A method for determining a transportation plan for a regional logistics network, the method comprising:
generating, by at least one processor, a transportation plan for packages scheduled to be routed through a regional logistics network such that the transportation plan minimizes transportation costs, the regional logistics network including depots and hubs, the depots including an origin depot and a destination depot, each depot being assigned a customer area serving one or more customers within the customer area, wherein the generating includes,
computing a pickup transportation plan for packages to be picked-up from the customers within the customer area of the origin depot;
computing a depot-to-depot transportation plan for packages transferred between the origin depot and the destination depot including determining whether the packages are to be transported via depot-to-depot routes or hub-to-hub routes, the depot-to-depot routes indicating to transfer the packages from the origin depot to the destination depot without using the hubs, the hub-to-hub routes indicating to transfer the packages from the origin depot to the destination depot using the hubs; and
computing a delivery transportation plan for delivering packages from the destination depot to the customers within the customer area of the destination depot, wherein the transportation plan includes the pickup transportation plan, the depot-to-depot transportation plan, and the delivery transportation plan.

19. The method of claim 18, wherein the computing the depot-to-depot transportation plan include determining a number of each type of vehicle for the depot-to-depot routes and the hub-to-hub routes.

20. The method of claim 18, wherein the computing the depot-to-depot transportation plan includes:
formulating the computation of the depot-to-depot transportation plan as an objective function that minimizes the transportation costs; and
solving the objective function in view of a first decision variable and a second decision variable, the first decision variable including the determination of whether the packages are to be transported via the depot-to-depot routes or the hub-to-hub routes, the second decision variable including the determination of the number of each type of vehicle for the depot-to-depot routes and the hub-to-hub routes.
